(19) United States
(12) Patent Application Publication
(10) Pub. No.: US 2017/0168584 A1
(43) Pub. Date: Jun. 15, 2017

(54) OPERATION SCREEN DISPLAY DEVICE, OPERATION SCREEN DISPLAY METHOD, AND NON-TEMPORARY RECORDING MEDIUM

(71) Applicant: NEC SOLUTION INNOVATORS, LTD., Koto-ku, Tokyo (JP)

(72) Inventor: Ryohtaroh TANIMURA, Tokyo (JP)

(73) Assignee: NEC SOLUTION INNOVATORS, LTD., Koto-ku, Tokyo (JP)

(21) Appl. No.: 15/309,564

(22) PCT Filed: Apr. 28, 2015
(86) PCT No.: PCT/JP2015/062784

§ 371 Date: Nov. 8, 2016

(30) Foreign Application Priority Data
May 8, 2014 (JP) 2014-096972

(51) Int. Cl. G06F 3/01

(52) U.S. Cl. CPC G06F 3/017; G06F 3/011

(57) ABSTRACT

An operation screen display device (1) displays, on a connected display (5), an operation screen operable by a user with a contactless motion. An image obtainer (11) obtains a depth image including the user from a depth sensor (2). An image analyzer (12) analyzes the obtained depth image, and extracts an image region corresponding to the user's body portion. A posture determiner (13) determines the user's posture status based on the extracted image region corresponding to the user's body portion. A display controller (16) creates the operation screen based on the user's posture status. Display means displays the created operation screen on the display (5).

### TECHNICAL FIELD

The present disclosure relates to an operation screen display device, an operation screen display method, and a non-transitory recording medium which display an operation screen that can be operated by a user with a contactless motion.

### BACKGROUND ART

According to present contactless gesture input technologies, the position of the user's hand is detected using a depth sensor and the like, a virtual operation region (operation plane or operation space) is set up ahead of the user, and operations, such as a pointing operation and a pushing operation, on the basis of the position of the hand are accomplished by contactless motion.

Patent Literature 1 discloses an information processing device which recognizes the posture of a human body or the gesture thereof based on the picked-up image, and which outputs a command in accordance with the recognized posture or gesture.

Patent Literature 2 discloses an image recognition device which reads the image of an operator, displays a three-dimensional image representing a virtual operation screen based on the read image of the operator and the position thereof, reads a motion of the operator relative to the virtual operation screen, and outputs a command in accordance with this motion.

Patent Literature 3 discloses an information input device which separates a foreground including a user from a background that is an environment other than the foreground, learns a three-dimensional model, estimates the position of an individual foreground model having undergone modeling beforehand and the posture thereof, recognizes, in particular, the user from the foreground, further recognizes the user's fingertip, and also recognizes the shape, position, and posture of the user's fingertip, thereby outputting a control command based on time-series information on the shape of the user's fingertip and the status change thereof.

### CITATION LIST

### Patent Literature

Patent Literature 1: Unexamined Japanese Patent Application Kokai Publication No. 2011-253292

Patent Literature 2: Unexamined Japanese Patent Application Kokai Publication No. 2011-175617

Patent Literature 3: Unexamined Japanese Patent Application Kokai Publication No. 2013-205983

### SUMMARY OF INVENTION

### Technical Problem

According to the above technologies, however, setting up a virtual operation region into a size and a position suitable for individual user is difficult, and thus the operation feeling is different depending on users. In addition, the pointing operation to the operation screen that is an object to which an operation is given is similar to a touch panel operation, resulting in a user interface that does not fully utilize the contactless feature.

When a contactless device is applied, a user does not obtain a feeling of touching a virtual operation region. Hence, the user needs to consciously carry out a work that is to adjust the position of the hand while viewing the operation screen in the air. Accordingly, the user's motion is likely to be a strained motion, resulting in a large load on the user's body due to the operation by contactless motion.

The technologies disclosed in Patent Literatures 1-3 do not have the shape of the operation screen irrelevant to the user's posture, thus not reducing the load on the user's body due to an operation by contactless motion.

The present disclosure has been made in view of the foregoing circumstances, and an objective is to provide a user interface which reduces a load on a user's body due to an operation by contactless motion, is instinctive, and facilitates an operation.

### Solution to Problem

An operation screen display device according to a first aspect of the present disclosure is an operation screen display device that displays, on a display, an operation screen operable by a user with a contactless motion, and the operation screen display device includes:

image obtaining means that obtains, from a depth sensor, a depth image including the user;

posture determining means that analyzes the obtained depth image, specifies an image region corresponding to a body portion of the user, and determines a posture status of the user based on the specified image region;

display control means that creates the operation screen based on the determined user's posture status; and

display means that displays the created operation screen on the display device.

An operation screen display method according to a second aspect of the present disclosure is an operation screen display method executed by an operation screen display device connected to a display, and the method includes:

an image analyzing step of analyzing a depth image including a user, and extracting an image region corresponding to a body portion of the user;

a posture determining step of determining a posture status of the user based on the extracted image region;

a display control step of creating, based on the determined user's posture status, an operation screen operable by the user with a contactless motion; and

a display step of displaying the created operation screen on the display.

A non-transitory recording medium according to a third aspect of the present disclosure has stored therein a program that causes a computer connected to a display to execute:

an image analyzing step of analyzing a depth image including a user, and extracting an image region corresponding to a body portion of the user;

a posture determining step of determining a posture status of the user based on the extracted image region of the user's body portion;

a display control step of creating an operation screen operable by the user with a contactless motion based on the determined user's posture status; and

a display step of displaying the created operation screen on the display.

### Advantageous Effects of Invention

According to the present disclosure, since the operation screen is displayed in accordance with the user's posture status, a user interface is provided which reduces a load on the user's body due to an operation by a contactless motion, is intuitive, and facilitates an operation.

### BRIEF DESCRIPTION OF DRAWINGS

FIG. 1 is a block diagram illustrating an example functional configuration of an operation screen display device according to an embodiment of the present disclosure;

FIG. 2 is a diagram illustrating an example posture determination according to the embodiment;

FIG. 3A is a diagram illustrating an example operation screen according to the embodiment;

FIG. 3B is a diagram illustrating an example operation screen according to the embodiment;

FIG. 4A is a diagram illustrating an example operation screen according to the embodiment;

FIG. 4B is a diagram illustrating an example operation screen according to the embodiment;

FIG. 5 is a diagram illustrating an example operation screen according to the embodiment;

FIG. 6A is a diagram illustrating an example set gesture according to the embodiment;

FIG. 6B is a diagram illustrating an example set gesture according to the embodiment;

FIG. 7 is a flowchart illustrating an example action of the operation screen display device according to the embodiment;

FIG. 8A is a diagram illustrating an example valid and invalid gesture according to another embodiment;

FIG. 8B is a diagram illustrating an example valid and invalid gesture according to another embodiment;

FIG. 9 is a diagram illustrating an example operation screen according to another embodiment; and

FIG. 10 is a block diagram illustrating an example hardware configuration of an operation screen display device according to an embodiment.

### DESCRIPTION OF EMBODIMENTS

Embodiments of the present disclosure will be explained below.

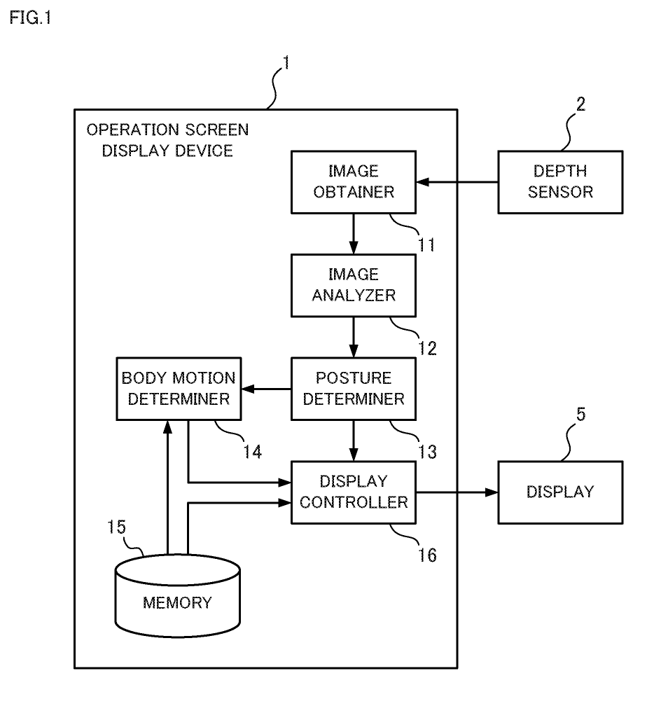

FIG. 1 is a block diagram illustrating an example functional configuration of an operation screen display device according to an embodiment of the present disclosure. An operation screen display device 1 is connected to a depth sensor 2 and a display 5, receives, from the depth sensor 2, data (depth image to be explained later) obtained by the depth sensor 2, and provides, to the display 5, information indicating a screen to be presented to a user.

The depth sensor 2 includes depth sensor elements laid out in an array and detecting a distance from an object, and collects up pieces of depth information supplied from the respective depth sensor elements as two-dimensional data, thereby generating a depth image. The obtained depth image is image data that represents data (depth distribution) indicating how far each portion of the object present in the imaging region is distant from the depth sensor 2. By referring to the depth image, a determination on which portion is close to the depth sensor 2, and which portion is further distant therefrom can be made. Hence, the depth of each object present in the imaging region can be known.

In addition, according to this embodiment, as an example, the depth sensor 2 is placed in the same direction as the display 5. That is, when there is a user who is viewing a screen displayed by the display 5, the depth sensor 2 is capable of obtaining a depth image of the region including this user.

The operation screen display device 1 includes an image obtainer 11, an image analyzer 12, a posture determiner 13, a body motion determiner 14, a memory 15, and a display controller 16.

The image obtainer 11 receives data transmitted from the depth sensor 2, and obtains the depth image. The image obtainer 11 transmits the obtained image to the image analyzer 12.

The image analyzer 12 analyzes the received depth image from the image obtainer 11, and extracts a region corresponding to the user's body, such as the user's hand or the user's arm. The image analyzer 12 transmits body region information indicating the region corresponding to the extracted user's body, such as the user's hand or the user's arm, to the posture determiner 13. More specifically, the body region information contains, for example, information indicating a body portion, such as “hand” or “arm”, and information on the position of the region associated with that portion in the obtained depth image and the range thereof.

The posture determiner 13 calculates, from the received body region information from the image analyzer 12, the depth value of the specific portion (body portion) of the user's body, such as the hand or the arm. More specifically, the region extracted as the specific portion, such as the user's hand, the user's arm or the like, is specified based on the received body region information, and the depth distribution of the specified region is read from the depth image. In addition, the posture determiner 13 estimates, based on the distribution information of the calculated depth value, the posture status of the user including the angle of the user's hand, the user's arm or the like, relative to the normal line of the screen of the display 5. More specifically, the direction of the user's specific portion (hand, arm or the like) is estimated based on the read depth distribution. The posture determiner 13 collects up pieces of information indicating the direction of the estimated user's specific portion, thereby generating posture information indicating the user's posture. The posture determiner 13 transmits the generated posture information to the body motion determiner 14.

In this embodiment, the posture determiner 13 records, beforehand, information indicating a positional relationship between the depth sensor 2 and the display 5 (information indicating that depth sensor 2 and display 5 are placed in the same direction). Hence, the posture determiner 13 is capable of estimating the user's posture relative to the screen of the display 5 based on the obtained depth image via the depth sensor 2. However, the depth sensor 2 and the display 5 may be placed in different directions. In this case, also, the positional relationship between the placed depth sensor 2 and display 5 should be recorded beforehand.

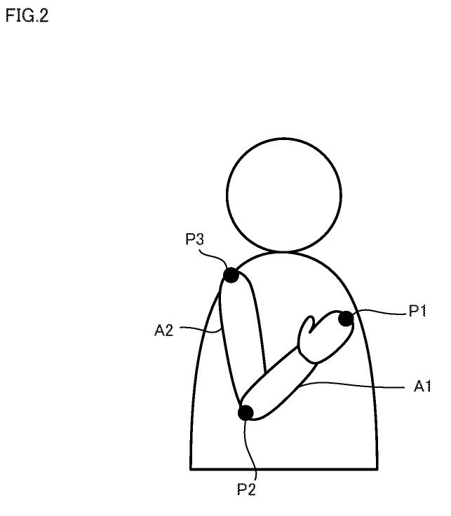

FIG. 2 is a diagram illustrating an example posture determination according to the embodiment. The image analyzer 12 extracts the region of the specific portion of the user's body, such as the user's hand or the user's arm, from the depth distribution of the depth image. In this embodiment, in particular, an explanation will be given of an example case in which an analysis is made based on the posture of the user's hand or that of the user's arm, and the motions thereof. There are various methods of extracting the region corresponding to the hand or the arm, but in this embodiment, a method of utilizing depth contour information will be explained. When the head of a human body, and the upper half of the body are within the depth image, a general skeleton recognition technology is applicable.

First, the image analyzer 12 searches, in the region including a contour that has a difference which is in upper and lower pixels in the depth obtained from the depth image and which is equal to or greater than a certain value (for example, 10 cm), a region that has a certain depth at the lower portion. In order to restrict the size of the region, an additional condition in which a position in not only the vertical direction but also the horizontal direction in the focused region has a depth difference of equal to or greater than the certain value may be applied. When the search results are sorted and stored while the regions with a close distance being integrated, a region that has an end portion like the user's fingertip is extracted.

When extracting the region corresponding to the user's fingertip, the image analyzer 12 searches the depth region from the extracted fingertip region to extract a region corresponding to the elbow. As for the searching, a searching end condition is determined from conditions, such as the area of the depth region contained between the fingertip and the elbow, the difference level in depth between the fingertip and the elbow, the difference in depth between the elbow and a background region corresponding to the body, and a standard human body size. Likewise, when extracting the region corresponding to the user's elbow, the image analyzer 12 searches the depth region from the extracted elbow region to extract a shoulder region. In this way, the image analyzer 12 analyzes the obtained depth image, and extracts an image region corresponding to the user's body portion.

The posture determiner 13 calculates, from the fingertip, elbow, and shoulder regions extracted by the image analyzer 12, posture information indicating the posture statuses of the user's hand, front arm and upper arm. Based on depth distribution information on the extracted fingertip, elbow, and shoulder regions, pieces of depth information on a fingertip P1, an elbow P2, and a shoulder P3, and the respective positions in the depth image are calculated. The fingertip P1 is a portion corresponding to the leading end of a user's front right arm A1. The elbow P2 is a portion corresponding to a joint between the user's front right arm A1 and a right upper arm A2. The shoulder P3 is a portion corresponding to a joint between the user's right upper arm A2 and the user's trunk.

The positional information in the depth image can be converted into positional information (x, y, z) in a global coordinate system with reference to the position of the depth sensor 2 based on the calculation by a special-purpose API of the depth sensor 2 or the field angle of the depth sensor 2 and the depth information. The directions in which the user's hand, front arm and upper arm are directed are detected from the converted positional information (x, y, z), and the posture status including the angle of the detected direction relative to the normal line of the screen of the display 5 can be estimated. In other words, the posture determiner 13 specifies the direction in which the user's body portion (front arm and upper arm) is directed relative to the depth sensor 2 based on the extracted image region. Note that in FIG. 1, the image analyzer 12 and the posture determiner 13 are illustrated as individual components, but a single component (for example, posture determiner 13) may have functions of analyzing the image, and determining the posture.

Returning to FIG. 1, the memory 15 of the operation screen display device 1 stores body information indicating the user's gesture defined beforehand and the operation detail corresponding thereto. In this case, the term gesture means a user's specific motion (for example, raising right hand). The memory 15 stores the body motion information that is a combination of the motion (gesture) to be made by the user and the operation detail associated to the motion.

The body motion determiner 14 checks the received posture information from the posture determiner 13 with the stored body motion information in the memory 15, and determines whether or not the user's motion is the stored gesture. More specifically, the body motion determiner 14 has a memory capacity capable of storing the received posture information from the posture determiner 13 in sequence. When receiving new posture information from the posture determiner 13, the body motion determiner 14 compares the newly received posture information with the posture information received last time. Upon the comparison of the posture information, the body motion determiner 14 specifies the portion that has a change in position among the portions of the user's body, and specifies how the portion changes (for example, moving direction). The body motion determiner 14 searches the body motion information based on the specified portion and how the portion changes, and checks whether or not there is a gesture that matches both the portion and how the portion changes. Upon the check-up, when the matching gesture is detected, the body motion determiner determines that the detected gesture is made.

As an example, when determining that the user's motion is an operation screen display gesture based on the received posture information from the posture determiner 13, the body motion determiner 14 transmits command information that indicates a command to display the operation screen, and the posture information to the display controller 16.

When receiving the command information that indicates the command to display the operation screen, and the posture information from the body motion determiner 14, the display controller 16 reads necessary information from the memory 15, and creates an operation screen based on the received posture information. More specifically, image data (that is a source of the operation screen) stored in the memory 15 is read, and the read image data is adjusted based on the received posture information, and thus the operation screen is created.

The display controller 16 creates the operation screen by perspective representation. For example, the display controller 16 displays the operation screen which is displayed so as to be viewable in parallel with a direction easy to move based on the angles of the user's hand, front arm and upper arm indicated by the posture information, and which has menus displayed so as to be selectable in sequence in the direction easy to move in accordance with the received posture information from the posture determiner 13, and the operation screen displayed and viewable in a manner deformed in accordance with the angles of the user's front arm and upper arm. In order to accomplish this operation screen, the display controller 16 reads the image data that is the source of the operation screen, and tilts this image data in accordance with the tilting level of the specified direction by the posture determiner 13 relative to the screen of the display 5, thereby creating the operation screen.

Note that depending on the posture information, the display controller 16 may display a menu for a different operation. When, for example, the front arm is vertical, an operation menu for display Forward and Backward may be displayed, and when the front arm is horizontal, an operation menu for volume Up and Down may be displayed.

The display controller 16 displays the created operation screen on the display 5. The display 5 may be built in the operation screen display device 1.

When the operation screen is displayed on the display 5, the body motion determiner 14 checks the received posture information from the posture determiner 13 with the body motion information stored in the memory 15, and determines whether or not the user's motion is a gesture of ending the operation screen (hereinafter, referred to as end gesture).

When determining that the end gesture is made, the body motion determiner 14 transmits command information that indicates a command to end the operation screen to the display controller 16.

When receiving the command information that indicates the command to end the operation screen from the body motion determiner 14, the display controller 16 ends the operation screen.

When determining that the user's motion is not the end gesture, the body motion determiner 14 checks the received posture information from the posture determiner 13 with the stored body motion information in the memory 15, and determines whether or not the user's motion is a gesture to set up a menu (hereinafter, referred to as set gesture).

When determining that the set gesture is made, the body motion determiner 14 transmits menu information that indicates a set menu to the display controller 16.

When receiving the menu information that indicates the set menu from the body motion determiner 14, the display controller 16 executes the menu indicated by the menu information. When necessary, the display controller 16 creates a menu execution screen that indicates the execution result of the menu, and displays this screen on the display 5.

Note that the menu set up by the user may be executed by an external device, and in this case, the body motion determiner 14 transmits the menu information to the external device. The external device executes the menu indicated by the menu information, creates the menu execution screen that indicates the execution result of the menu and displays this screen on the display 5 when necessary.

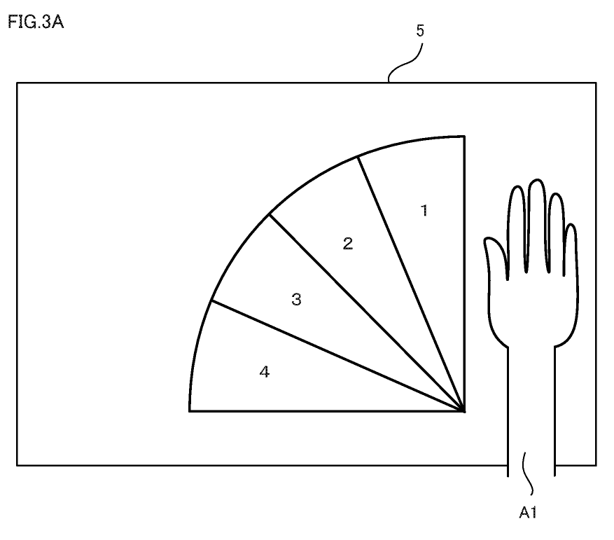

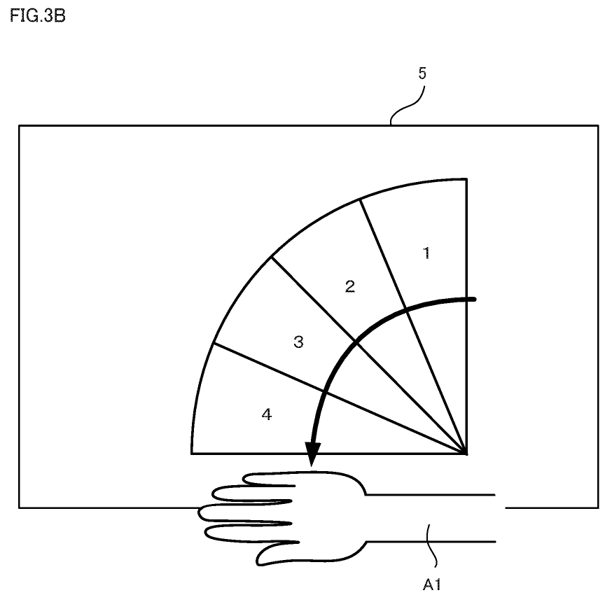

FIG. 3A and FIG. 3B are each a diagram illustrating an example operation screen according to this embodiment. In the example illustrated in FIG. 3A, the user is standing so as to face the front surface of the display 5, and a body motion of raising the front right arm A1 in the vertical direction for a predetermined time, and of directing the palm of the right hand forward is determined as an operation screen display gesture.

As illustrated in FIG. 3A, when the operation screen display gesture is given, the display controller 16 displays, on the display 5, the operation screen in accordance with a user's motion of putting down the raised right hand to the left (tilting the front right arm A1 to the left around the upper arm). The operation screens in a sector shape display respective menus 1-4 in a manner selectable in sequence in the direction in which the user puts down the raised right hand to the left.

As illustrated in FIG. 3B, when the user gives a motion of tilting the raised right hand to the left (tilting the front right arm A1 to the left around the upper arm), the menus are selectable in the order of 1-4 in sequence.

The end gesture is, for example, a body motion of putting down the hand for a predetermined time. A set gesture to set up the menu will be explained later.

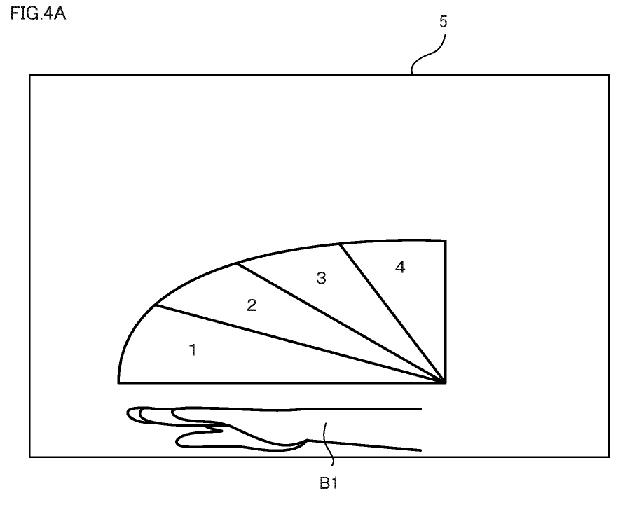

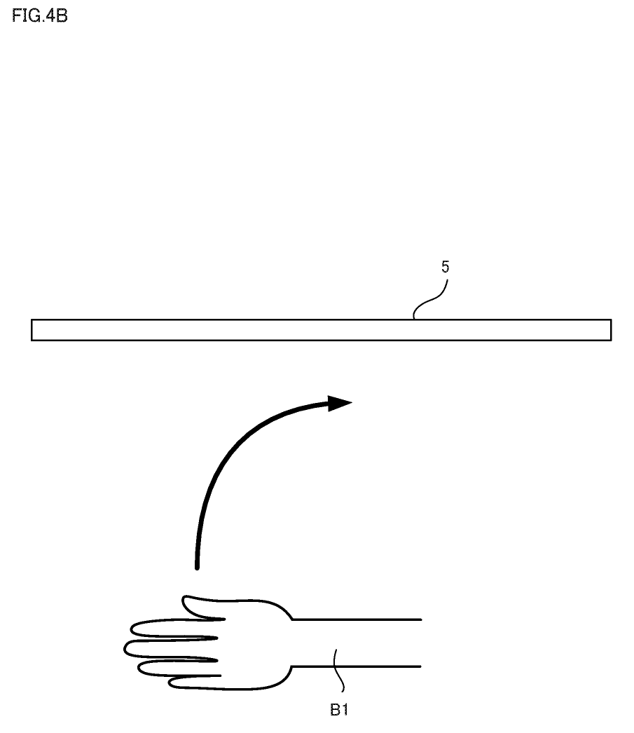

FIG. 4A and FIG. 4B are each a diagram illustrating an example operation screen according to this embodiment. In the example illustrated in FIG. 4A, the user is standing so as to face the front surface of the display 5, and a body motion of extending a left front arm B1 in the horizontal direction, and of directing the palm of the left hand downwardly for a predetermined time is determined as an operation screen display gesture.

As illustrated in FIG. 4A, when the operation screen display gesture is given, the display controller 16 displays, on the display 5, the operation screen in accordance with the user's motion of moving the left hand extended in the horizontal direction forward. The operation screens in a sector shape display the respective menus 1-4 in a manner selectable in sequence in the direction in which the user moves the left front arm B1 extended in the horizontal direction forward. In addition, the operation screens in a sector shape are displayed in a manner deformed so as to be viewable with a depth by the user by perspective representation.

FIG. 4B is a top view. As illustrated in FIG. 4B, when the user gives a motion of moving the left hand extended in the horizontal direction forward, the menus are selectable in the order of 1-4 in sequence.

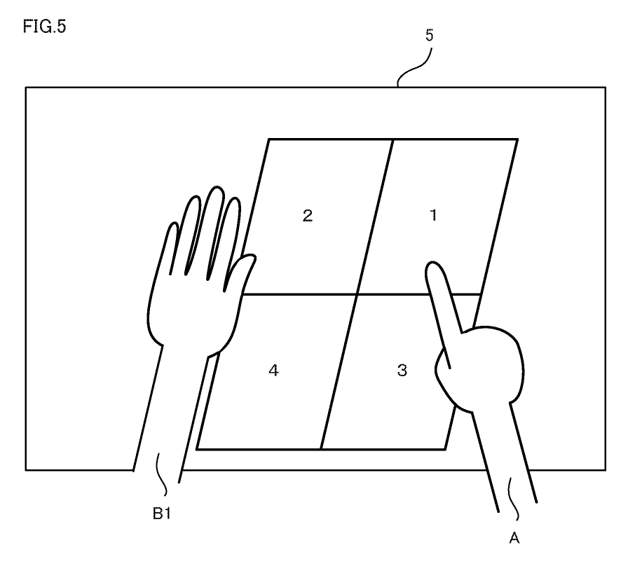

FIG. 5 is a diagram illustrating an example operation screen according to this embodiment. In the example illustrated in FIG. 5, the user is standing so as to face the front surface of the display 5, and a body motion of raising the left front arm B1 at an arbitrary angle for a predetermined time, and of directing the palm of the left hand forward is determined as an operation screen display gesture.

As illustrated in FIG. 5, when the user gives the operation screen display gesture, the display controller 16 displays, on the display 5, the operation screen that is viewable in accordance with the angle of the user's left front arm B1 by perspective representation. When the user changes the angle of the left front arm B1, the rectangular operation screen is displayed in a manner deformed in such a way that the tilting level of this screen is changed in accordance with the change in angle of the user's left front arm. In addition, the content of the operation menu displayed may be changed in accordance with the angle of the left front arm B1. In this case, the menu is selected by, for example, the pointing motion by the right hand A.

An explanation will now be given of the set gesture to set up the menu.

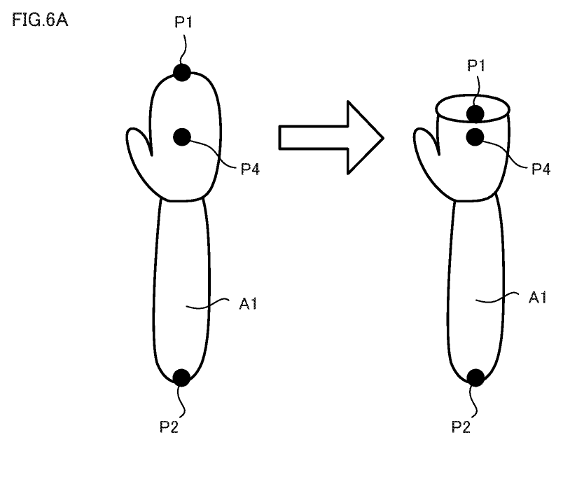

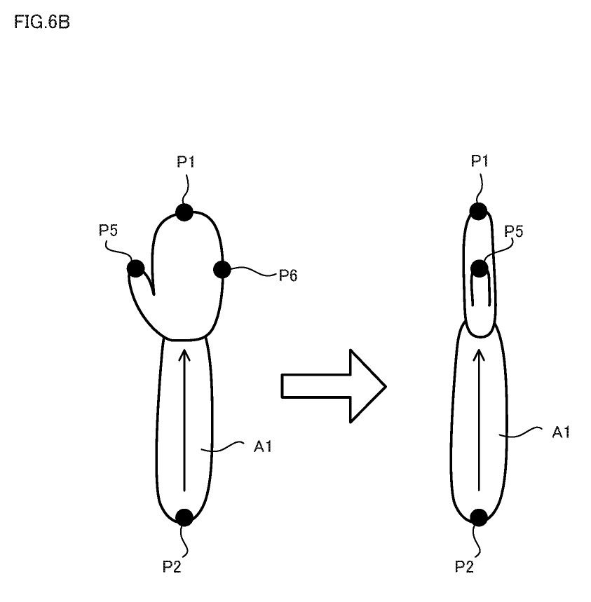

FIG. 6A and FIG. 6B are each a diagram illustrating an example set gesture according to this embodiment. In the example illustrated in FIG. 6A, a positional change of the fingertip P1 and that of a hand center P4 are extracted, and a body motion of moving the fingertip P1 ahead of the hand center P4 with reference to the elbow P2 (pulling down fingertip only) is determined as the set gesture. Note that when the shape of the hand changes, the fingertip P1 may be positioned as being estimatable as the fingertip based on a single finger or equal to or greater than two fingers.

In the example illustrated in FIG. 6B, a positional change of a left end portion P5 and that of a right end portion P6 vertical to the direction from the elbow P2 toward the fingertip P1 are extracted, and a body motion of turning the palm of the hand is determined as the set gesture. The turning angle of the palm of the hand may be an angle appropriate for an applied scene, such as 90 degrees or 180 degrees, by parameter setting.

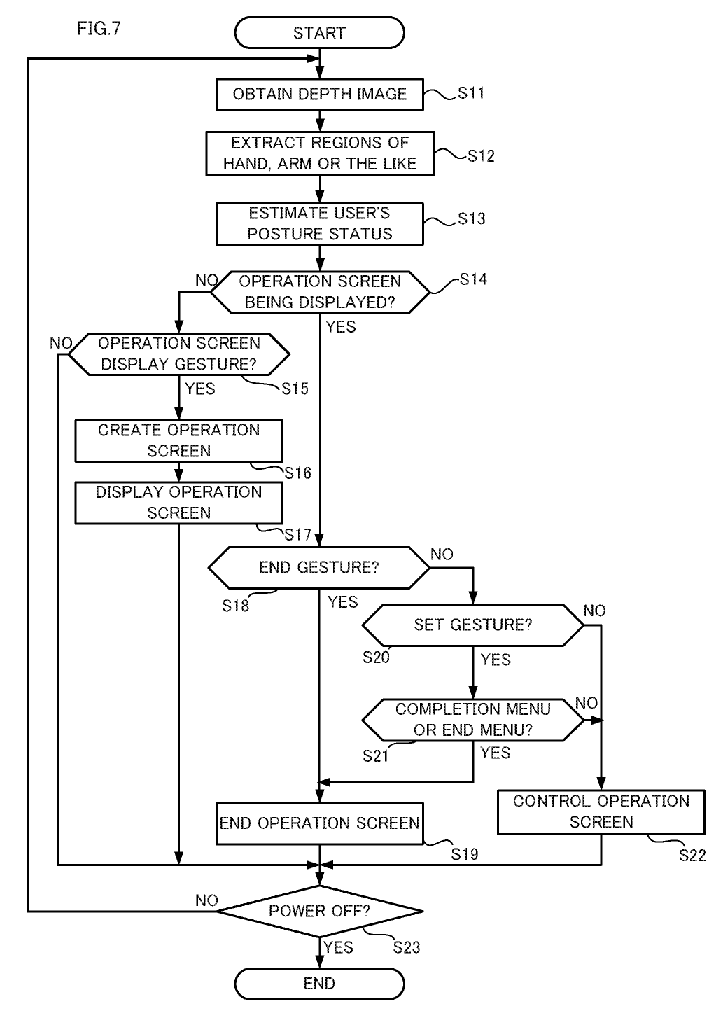

FIG. 7 is a flowchart illustrating an example action of the operation screen display device according to this embodiment. When the power of the operation screen display device 1 is turned ON, the operation screen displaying process in FIG. 7 starts.

The image obtainer 11 of the operation screen display device 1 obtains the depth image from the depth sensor 2, and transmits the obtained image to the image analyzer 12 (step S11).

The image analyzer 12 analyzes the received depth image from the image obtainer 11, and extracts the regions of the user's hand, arm, or the like (step S12). The image analyzer 12 transmits, to the posture determiner 13, body region information indicating the extracted regions of the user's hand, arm, or the like.

The posture determiner 13 calculates the depth value of the user's hand or that of the user's arm based on the received body region information from the image analyzer 12. The posture determiner 13 detects the direction of the user's hand or that of the user's arm based on distribution information of the calculated depth values, estimates the user's posture status that indicates in which direction this body portion is directed toward the screen of the display 5, and transmits the posture information that indicates the estimated posture to the body motion determiner 14 (step S13).

When the operation screen is not being displayed (step S14: NO), the body motion determiner 14 checks the received posture information from the posture determiner 13 with the stored body motion information in the memory 15, and determines whether or not the user's motion is the operation screen display gesture (step S15).

When the user's motion is the operation screen display gesture (step S15: YES), the body motion determiner 14 transmits, to the display controller 16, the command information that indicates the command to display the operation screen, and the posture information.

When receiving, from the body motion determiner 14, the command information that indicates the command to display the operation screen, and the posture information, the display controller 16 reads necessary information from the memory 15, and creates an operation screen in accordance with the received posture information (step S16). The display controller 16 displays the created operation screen on the display 5 (step S17), and the process progresses to step S23.

When the user's motion is not the operation screen display gesture (step S15: NO), the process progresses to the step S23.

Conversely, when the operation screen is being displayed (step S14: YES), the body motion determiner 14 checks the received posture information from the posture determiner 13 with the body motion information stored in the memory 15, and determines whether or not the user's motion is the end gesture (step S18).

When the user's motion is the end gesture (step S18: YES), the body motion determiner 14 transmits, to the display controller 16, the command information that indicates the command to end the operation screen.

When receiving the command information that indicates the command to end the operation screen from the body motion determiner 14, the display controller 16 ends the operation screen (step S19), and the process progresses to the step S23.

When the user's motion is not the end gesture (step S18: NO), the body motion determiner 14 checks the received posture information from the posture determiner 13 with the body motion information stored in the memory 15, and determines whether or not the user's motion is the set gesture (step S20).

When the user's motion is the set gesture (step S20: YES), the body motion determiner 14 transmits, to the display controller 16, the menu information that indicates the set menu.

The display controller 16 determines whether the set menu is a completion menu that indicates the selected operation menu and the completion of the selection or an end menu for ending the operation screen without the operation menu being selected (step S21).

When the set menu is the completion menu or the end menu (step S21: YES), the display controller 16 executes the completion menu or the end menu to end the operation screen (step S19), and the process progresses to the step S23.

When the set menu is not the completion menu or the end menu (step S21: NO), the display controller 16 controls the operation screen in accordance with the set menu (step S22), and the process progresses to the step S23.

Conversely, when the user's motion is not the set gesture (step S20: NO), the body motion determiner 14 transmits the posture information to the display controller 16. The display controller 16 controls the operation screen in accordance with the received posture information from the body motion determiner 14 (step S22).

When the power of the operation screen display device 1 is not turned OFF (step S23: NO), the process returns to the step S11, and the steps S11-S23 are repeated. When the power of the operation screen display device 1 is turned OFF (step S23: YES), the process ends.

In the example illustrated in FIG. 7, a determination on whether the set menu is the completion menu or the end menu is made in the step S21, but the present disclosure is not limited to this example case, and when the user gives the set gesture with the operation menu being selected, the selection of the operation menu may be completed.

In this case, the step S21 may be omitted, and when determining that the set gesture is given (step S20: YES), the body motion determiner 14 transmits, to the display controller 16, the command information that indicates the command to end the operation screen, and the menu information that indicates the selected operation menu. The display controller 16 ends the operation screen, and executes the selected operation menu.

The operation screen display device 1 according to this embodiment displays the operation screen in a manner changing the shape thereof in accordance with the user's posture status in such a way that the operation screen is viewable in the direction in which the user's body portion is moved. Hence, a user interface is provided which reduces the load to the user's body due to an operation by contactless motion, is intuitive, and facilitates an operation. In addition, since the operation screen display device 1 changes the operation screen in accordance with the user's posture, the user can easily sense an operation feeling, and a difference in operability is not likely to be caused regardless of the user who is an adult or a child. In addition, since the user is enabled to give an operation by contactless motion in such a way that the user's hand or arm is utilized as a controller, an adverse effect of a change in operability due to the operation posture is reduced, and the operation is enabled by the minimum motion.

In the above embodiment, the image analyzer 12 of the operation screen display device 1 extracts the regions of the user's hand, arm, or the like from the depth image, and the posture determiner 13 estimates the user's posture status including the angle of the user's hand or that of the user's arm relative to the normal line of the screen of the display 5. However, the present disclosure is not limited to this example case, and the user's posture status may include, for example, the angle of the user's head or upper body relative to the normal line of the screen of the display 5. When the regions of the user's head and upper body are extracted, the background of the fingertip or the connected region by a search for the depth region is extracted as a candidate of the head or the upper body. Assuming that the user has a certain difference in depth from the peripheral region, by performing a labeling process on the peripheral region within the certain depth to separate such a region, the user's body region including the fingertip can be extracted and specified.

In the direction in which the front arm and the upper arm are bent and stretched, the movable range of the front arm substantially remains the same with reference to the upper body. When, however, the front arm is turned around the upper arm, the movable range of the front arm changes in accordance with the positional relationship with the upper body. Hence, by detecting the direction of the upper body, in particular, the angle of the upper body and the upper arm and that of the upper body and the front arm, the movable range of the front arm or the upper arm can be specified. In addition, the display controller 16 of the operation screen display device 1 disposes the menu of the operation screen in accordance with the movable range of the user's front arm or upper arm.

In the above embodiment, the explanation has been given of the operation screen display gesture and the set gesture. However, gestures associated with other functions may be adopted.

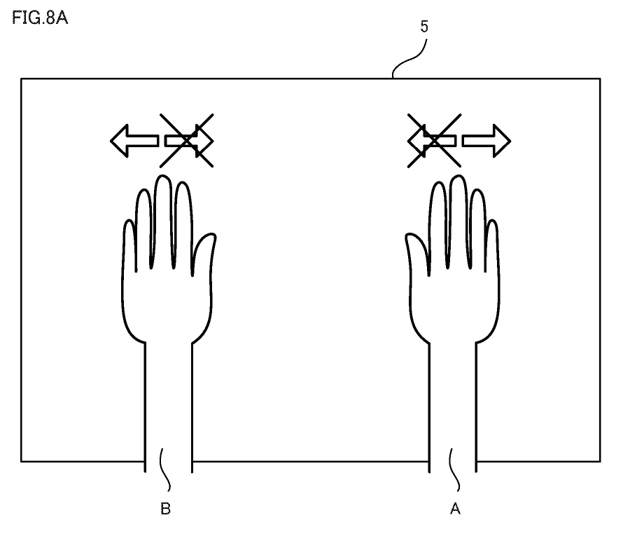

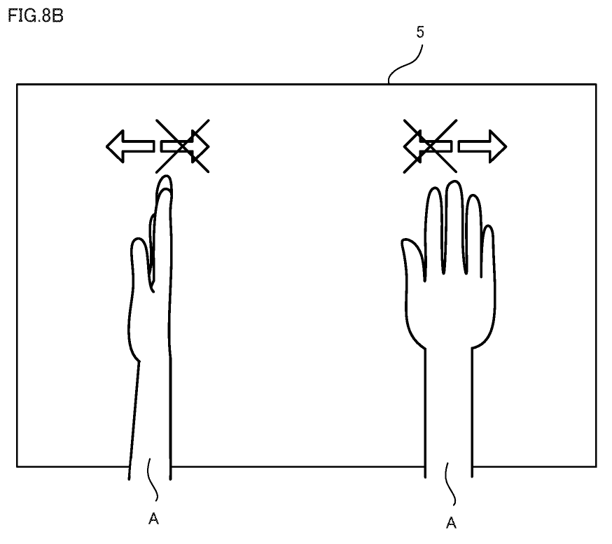

FIG. 8A and FIG. 8B are each a diagram illustrating an example valid and invalid gesture according to another embodiment. In the example illustrated in FIG. 8A, when the user selects the menu from the operation screen, and when the operation is given by a right hand A, the motion in the rightward direction is valid, while the motion in the leftward direction is invalid, and when the operation is given by a left hand B, the motion in the leftward direction is valid, while the motion in the rightward direction is invalid. In the example illustrated in FIG. 8B, when the user selects the menu from the operation screen, and when the operation is given with the palm of the right hand A being directed forward, the motion in the rightward direction is valid, while the motion in the leftward direction is invalid, and when the operation is given with the palm of the right hand A being directed leftward, the motion in the leftward direction is valid, while the motion in the rightward direction is invalid.

This does not cause a motion not intended by the user in a natural motion, such as switching the hand or putting down the hand. The valid and invalid gesture is not limited to the examples in FIG. 8A and FIG. 8B, and other shapes of the user's hand may be associated with the validity and the invalidity beforehand.

In the above explanation, when the user gives a contactless operation to the operation screen, the direction in which the body portion is moved is a single direction, but the present disclosure is not limited to this case. For example, the menu may be selected based on two directions that are the direction in which the front arm is bent and stretched relative to the upper arm, and the direction in which the front arm is turned around the upper arm. In this case, for example, the operation screen may be configured in such a way that the upper-rank menu screens are changed in accordance with the direction in which the front arm is bent and stretched relative to the upper arm, and the menu field is selected in accordance with the direction in which the front arm is turned around the upper arm.

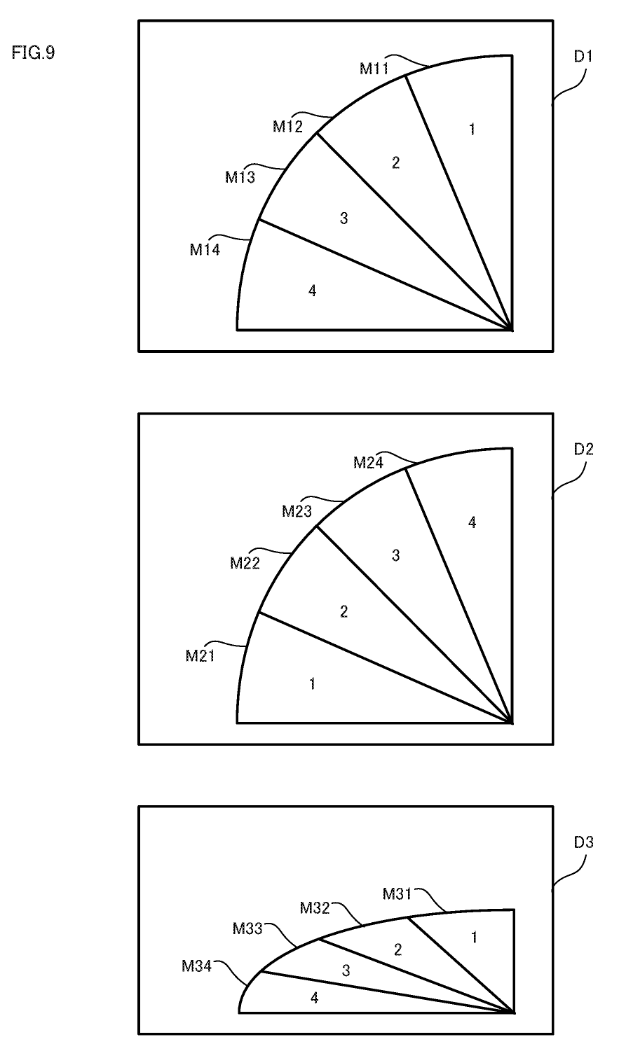

In the above explained example, the operation screen display device 1 connected to the depth sensor 2 displays the operation screen by perspective representation based on the depth image. However, the scope of the present disclosure is not limited to this case. The operation screen display device 1 may record options screen patterns in accordance with respective expected user's postures, and may select a screen option in accordance with the user's posture when the actual operation screen display gesture is given. In this case, more specifically, as illustrated in FIG. 9, the operation screen display device 1 store options screen patterns D1, D2, D3. The options screen pattern D1 is a options screen pattern when the operation screen display gesture with the user's right arm being directed upward is given. The options screen pattern D2 is a options screen pattern when the operation screen display gesture with the user's right arm being directed leftward is given. The options screen pattern D3 is a options screen pattern when the operation screen display gesture with the user's right hand being directed forward (direction toward depth sensor 2).

In this case, the operation screen display device 1 displays the options screen pattern D1 when the operation screen display gesture is detected and when the user's right arm is directed vertically upward. In the options screen pattern D1, a field M11 is displayed at an area tilted slightly leftward in the figure relative to the vertical upward direction. A field M12 is displayed at an area further tilted leftward in the figure more than the field M11, and a field M13 and a field M14 are also displayed as the tilting angle increases. When the options screen pattern D1 is displayed, the user is capable of selecting an option displayed in the field M11 by slightly tilting the right arm leftward. In addition, by increasing the tilting angle of the right arm, the user is capable of selecting the operation details indicated in the fields M12-M14 in sequence.

Conversely, when the operation screen display gesture is detected and when the user's right hand is directed leftward in the figure, the operation screen display device 1 displays the options screen pattern D2. In the options screen pattern D2, with reference to the left horizontal direction, a field M21 is displayed at an area tilted upward in the figure, and fields M22-M24 are displayed as the tilting angle increases. In this case, the user is capable of selecting the option displayed at an arbitrary field among the fields M21-M24 by gradually tilting the right arm upward from a condition in which such a right arm is directed leftward. In addition, when the operation screen display gesture is detected and when the user's right arm is directed forward, the user is also capable of selecting the option displayed among fields M31-M34 by gradually changing the direction of the right arm from the front side toward the left side.

As explained above, by changing the operation screen in accordance with the user's posture information when the operation screen display gesture is detected, in any cases, the option can be presented with a little load to the user's body. That is, when the user's right arm is directed vertically upward, the user is capable of selecting the option by a motion of gradually tilting the right arm leftward which has relatively little load. When the user's right arm is directed leftward, and also forward, a selection is enabled by a motion that has relatively little load.

In addition, the operation screen selected in accordance with the user's posture information may be tilted further by perspective representation. That is, the operation screen display device 1 may select the operation screen to be displayed among options screen patterns like three patterns recorded beforehand in accordance with the user's posture status when the operation screen display gesture is detected, and the selected operation screen may be further tilted in accordance with the user's posture status. This scheme enables the operation screen that further matches the user's posture to be displayed.

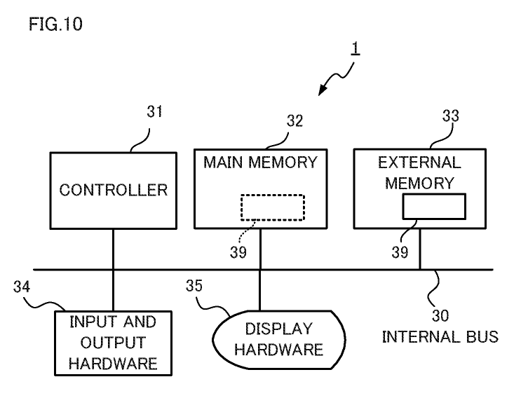

FIG. 10 is a block diagram illustrating an example hardware configuration of the operation screen display device according to this embodiment.

The controller 31 includes, for example, a Central Processing Unit (CPU), and executes the respective processes of the image analyzer 12, the posture determiner 13, the body motion determiner 14, and the display controller 16 in accordance with a control program 39 stored in an external memory 33.

A main memory 32 includes, for example, a Random-Access Memory (RAM), loads therein the control program 39 stored in the external memory 33, and is utilized as a work area for the controller 31.

The external memory 33 includes, for example, a non-volatile memory, such as a flash memory, a hard disk, a Digital Versatile Disc Random-Access Memory (DVD-RAM), or a Digital Versatile Disc ReWritable (DVD-RW), stores beforehand a program for causing the controller 31 to execute the process of the operation screen display device 1, supplies data stored by this program to the controller 31 in accordance with an instruction therefrom, and stores data supplied from the controller 31. The memory 15 is accomplished by the external memory 33.

Input-output hardware 34 includes a serial interface or a parallel interface. The input-output hardware 34 is connected to the depth sensor 2, and functions as the image obtainer 11. When the operation screen display device 1 is connected to an external device, the input-output hardware 34 is connected to such an external device.

Display hardware 35 includes a CRT or an LCD. In the case of a structure in which the display 5 is built in the operation screen display device 1, the display hardware 35 functions as the display 5.

The processes by the image obtainer 11, the image analyzer 12, the posture determiner 13, the body motion determiner 14, the memory 15 and the display controller 16 are the processes of the control program 39 that utilizes resources which are the controller 31, the main memory 32, the external memory 33, the input-output hardware 34, and the display hardware 35.

In addition, the above hardware configuration and flowchart are merely examples, and various changes and modifications can be made as appropriate.

The major part which includes the controller 31, the main memory 32, the external memory 33, and an internal bus 30 and which executes the control process can be accomplished by not only a special-purpose system but also a general computer system. For example, a computer program to execute the above actions may be distributed in a manner stored in a non-transitory computer-readable recording medium (for example, a flexible disk, a CD-ROM or a DVD-ROM), and may be installed in a computer to accomplish the operation display device 1 that executes the above processes. In addition, the computer program may be stored in a storage device of a server device over a communication network like the Internet, and may be downloaded to a general computer system to accomplish the operation screen display device 1.

In addition, when, for example, the function of the operation screen display device 1 is shared by an OS and an application program or is accomplished by the cooperative operation of the OS and the application, only the application program portion may be recorded in a non-transitory recording medium or a storage device.

Still further, the computer program may be superimposed on carrier waves, and may be distributed via the communication network. For example, the computer program may be posted on a Bulletin Board System (BBS) over the communication network, and may be distributed via the network. In addition, by running and executing this computer program like the other application programs under the control of the OS, execution of the above process may be enabled.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

A part of or all of the above embodiment can be expressed as the following supplementary notes but the present disclosure is not limited to the following supplementary notes.

(Supplementary Note 1)

An operation screen display device that displays, on a display, an operation screen operable by a user with a contactless motion, the operation screen display device including:

image obtaining means that obtains, from a depth sensor, a depth image including the user;

posture determining means that analyzes the obtained depth image, specifies an image region corresponding to a body portion of the user, and determines a posture status of the user based on the specified image region;

display control means that creates the operation screen based on the determined user's posture status; and

display means that displays the created operation screen on a screen of the display device.

(Supplementary Note 2)

The operation screen display device according to supplementary note 1, in which:

the posture determining means specifies, based on the specified image region, a direction in which the user's body portion is directed relative to the depth sensor; and

the display control means creates the operation screen based on the specified direction and the positional relationship between the screen of the display recorded beforehand and the depth sensor.

(Supplementary Note 3)

The operation screen display device according to supplementary note 1, in which:

the posture determining means specifies, based on the specified image region, a direction in which the user's body portion is directed relative to the depth sensor; and

the display control means creates the operation screen based on the specified direction and the positional relationship between the screen of the display recorded beforehand and the depth sensor.

(Supplementary Note 4)

The operation screen display device according to supplementary note 1, in which the posture determining means determines the user's posture status including an angle of the user's body portion relative to a normal line of the screen of the display based on a positional relationship recorded beforehand between the screen of the display and the depth sensor, and the specified image region.

(Supplementary Note 5)

The operation screen display device according to supplementary note 4, in which the display control means creates the operation screen including a selectable menu indicating an operation detail so as to be viewable in a direction easy to move the user's body portion by perspective representation from an angle of the determined user's body portion by the posture determining means relative to the normal line of the screen of the display.

(Supplementary Note 6)

The operation screen display device according to supplementary note 4, in which the display control means creates the operation screen that is deformed in accordance with an angle of the user's one arm from an angle of the determined user's body portion by the posture determining means relative to the normal line of the screen of the display.

(Supplementary Note 7)

The operation screen display device according to supplementary note 1, further including:

memory means that stores body motion information indicating a predetermined body motion and an operation detail corresponding to the body motion; and

body motion determining means that recognizes the body motion made by the user based on the user's posture status determined by the posture determining means, and checks the recognized body motion with the body motion information to detect the operation detail given by the user,

in which the body motion determining means determines, based on the user's posture status determined by the posture determining means, a motion in a predetermined direction as valid when the user gives the operation to the operation screen by a first hand shape, and a motion in an other direction different from the predetermined direction as invalid, and determines the motion in the other direction as valid when the user gives the operation to the operation screen by a second hand shape different from the first hand shape, and determines the motion in the predetermined direction as invalid.

(Supplementary Note 8)

An operation screen display method executed by an operation screen display device connected to a display, the method including:

an image analyzing step of analyzing a depth image including a user, and extracting an image region corresponding to a body portion of the user;

a posture determining step of determining a posture status of the user based on the extracted image region;

a display control step of creating, based on the determined user's posture status, an operation screen operable by the user with a contactless motion; and
a display step of displaying the created operation screen on the display.

(Supplementary Note 9)

A non-transitory recording medium having stored therein a program that causes a computer connected to a display to execute:

an image analyzing step of analyzing a depth image including a user, and extracting an image region corresponding to a body portion of the user;

a posture determining step of determining a posture status of the user based on the extracted image region of the user's body portion;

a display control step of creating an operation screen operable by the user with a contactless motion based on the determined user's posture status; and

a display step of displaying the created operation screen on the display.

This application is based upon Japanese Patent Application No. 2014-96972 filed on May 8, 2014. The entire specification, claims, and drawings of Japanese Patent Application No. 2014-96972 are herein incorporated in this specification by reference.

### REFERENCE SIGNS LIST

1 Operation screen display device
2 Depth sensor
5 Display
1 Image obtainer
12 Image analyzer
13 Posture determiner
14 Body motion determiner
15 Memory
16 Display controller
30 Internal bus
31 Controller
32 Main memory
33 External memory
34 Input-output hardware
35 Display hardware
39 Control program
P1 Fingertip
P2 Elbow
P3 Shoulder
P4 Center of hand
P5 Left end
P6 Right end

What is claimed is:

1. An operation screen display device that displays, on a display, an operation screen operable by a user with a contactless motion, the operation screen display device comprising:
an image obtainer that obtains, from a depth sensor, a depth image including the user;
a posture determiner that analyzes the obtained depth image, specifies an image region corresponding to a body portion of the user, and determines a posture status of the user based on the specified image region;
a display controller that creates the operation screen based on the determined user's posture status; and
a display that displays the created operation screen on a screen of the display.

2. The operation screen display device according to claim 1, wherein:
the posture determiner specifies, based on the specified image region, a direction in which the user's body portion is directed relative to the depth sensor; and
the display controller control creates the operation screen based on the specified direction and the positional relationship between the screen of the display recorded beforehand and the depth sensor.

3. The operation screen display device according to claim 2, wherein the display controller reads recorded image data that is a source of the operation screen, and creates the operation screen by tilting the read image data in accordance with a tilting level of the specified direction relative to the screen of the display.

4. The operation screen display device according to claim 1, wherein the posture determiner determines the user's posture status including an angle of the user's body portion relative to a normal line of the screen of the display based on a positional relationship recorded beforehand between the screen of the display and the depth sensor, and the specified image region.

5. The operation screen display device according to claim 4, wherein the display controller creates the operation screen including a selectable menu indicating an operation detail so as to be viewable in a direction easy to move the user's body portion by perspective representation from an angle of the determined user's body portion by the posture determiner relative to the normal line of the screen of the display.

6. The operation screen display device according to claim 4, wherein the display controller creates the operation screen that is deformed in accordance with an angle of the user's one arm from an angle of the determined user's body portion by the posture determiner relative to the normal line of the screen of the display.

7. The operation screen display device according to claim 1, further comprising:
a memory that stores body motion information indicating a predetermined body motion and an operation detail corresponding to the body motion; and
a body motion determiner that recognizes the body motion made by the user based on the user's posture status determined by the posture determiner, and checks the recognized body motion with the body motion information to detect the operation detail given by the user,
wherein the body motion determiner determines, based on the user's posture status determined by the posture determiner, a motion in a predetermined direction as valid and a motion in an other direction different from the predetermined direction as invalid when the user gives the operation to the operation screen by a first hand shape, and determines the motion in the other direction as valid and determines the motion in the predetermined direction as invalid when the user gives the operation to the operation screen by a second hand shape different from the first hand shape.

8. An operation screen display method executed by an operation screen display device connected to a display, the method comprising:
an image analyzing step of analyzing a depth image including a user, and extracting an image region corresponding to a body portion of the user;
a posture determining step of determining a posture status of the user based on the extracted image region;
a display control step of creating, based on the determined user's posture status, an operation screen operable by the user with a contactless motion; and
a display step of displaying the created operation screen on the display.

9. A non-transitory recording medium having stored therein a program that causes a computer connected to a display to execute:
an image analyzing step of analyzing a depth image including a user, and extracting an image region corresponding to a body portion of the user;
a posture determining step of determining a posture status of the user based on the extracted image region of the user's body portion;
a display control step of creating an operation screen operable by the user with a contactless motion based on the determined user's posture status; and
a display step of displaying the created operation screen on the display.
